(19) United States
(12) Patent Application Publication
(10) Pub. No.: US 2006/0278536 A1
(43) Pub. Date: Dec. 14, 2006

(54) Sensor comprising supported aprotic ionic liquid

(75) Inventors: Anthony K. Burrell, Los Alamos, NM (US); Simon B. Hall, Palmerston North (NZ); Benjamin P. Warner, Los Alamos, NM (US); Wayne H. Smith, Los Alamos, NM (US); Jerzy Chlistunoff, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/151,150

(22) Filed: Jun. 10, 2005

(51) Int. Cl. G01N 27/26

(52) U.S. Cl. 205/775; 204/400

(57) ABSTRACT

A sensor for detecting and measuring analyte includes a working electrode, a counter electrode, and a porous support positioned in between and in contact with the working electrode and the counter electrode. At least one of the working electrode and the counter electrode is perforated. Aprotic ionic liquid fills the pores and is adsorbed on the surface of the porous support. The sensor also includes an electrical power source that provides a controlled voltage difference between the working electrode and the counter electrode, and an ammeter that measures the current flowing from the working electrode to the counter electrode.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to analyte detection and more particularly to an electrochemical sensor having a supported, aprotic ionic liquid.

### BACKGROUND OF THE INVENTION

The rapid detection of hazardous chemical agents (environmental toxins, nerve gases, and the like) is a particularly challenging problem. Early detection of these toxic substances is necessary to provide adequate time to seek shelter or don protective clothing and equipment to minimize exposure. Sensors for detecting these types of materials should be lightweight, inexpensive, respond rapidly, and employ the minimum of ancillary support equipment. Such detectors may also be useful in determining the efficacy of protective clothing and equipment.

Early detection will facilitate the rapid and efficient containment and remediation of the chemical release. Detection will also assist with minimization of the spatial extent of the release, mapping of he release area and determine sites and localities for personnel exclusion and focused efforts for destruction of the chemical release. This is crucial in both military and non-military applications where chemical weaponry may be rapidly deployed or chemical spills and release may occur without warning.

In industrial and commercial scenarios, the rapid detection of environmental toxins, in say the event of chemical and/or accidental releases from chemical plants, or from excessive horticultural spraying and the like is critical for protecting the well-being of surrounding residents and industrial workers.

There remains a need for improved sensors that detect hazardous materials.

Accordingly, an object of the invention is to provide a sensor that detects hazardous materials.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, the present invention includes a sensor for sensing analyte in a test atmosphere. The sensor has a first electrode, a second electrode, and a porous support in electrical communication with the first electrode and the second electrode. The porous support includes aprotic ionic liquid in the support. The sensor also includes an electrical power source for providing a controlled voltage difference between the first electrode and the second electrode. The sensor also includes an ammeter in electrical communication with the first electrode and the second electrode. At least a portion of the porous support is capable of coming into contact with an analyte.

The invention also includes a method for sensing analyte. The method involves exposing a porous support to an analyte, applying a controlled voltage difference across the porous support, and thereafter measuring the current flowing across the porous support. The porous support includes aprotic ionic liquid in the membrane.

The invention also includes a method for sensing analyte. The method involves exposing a porous support comprising aprotic ionic liquid to an analyte, applying a controlled electrical current across the porous support, and thereafter measuring the voltage across the porous support.

### BRIEF DESCRIPTION OF THE DRAWINGS

The accompanying drawings, which are incorporated in and form a part of the specification, illustrate the embodiment(s) of the present invention and, together with the description, serve to explain the principles of the invention. In the drawings:

FIG. 1 shows an edge-on view of an embodiment of a sensor of the present invention.

FIG. 2 shows a perspective view of the embodiment sensor shown in FIG. 1.

FIG. 3 shows a baseline graph of the current-time response of the embodiment detector shown in FIG. 1 in the absence of sensed analyte.

FIG. 4 shows the current-time response of the embodiment detector shown in FIG. 1 in the presence of diethyl ether and of solutions of methyl salicylate in diethyl ether.

FIG. 5 shows the response (in terms of change in current as a function of mass of methyl salicylate) of the embodiment detector shown in FIG. 1 in the presence of solutions of methyl salicylate in diethyl ether; and

FIG. 6 shows the response of the embodiment detector shown in FIG. 1 in the absence and presence of two concentrations of a gaseous stream of the nerve gas surrogate half-mustard.

### DETAILED DESCRIPTION

Briefly, the present invention is concerned with a sensor having a porous solid support with a small amount of ionic liquid in the support. The porous support with ionic liquid therein is collectively referred to herein as a “supported ionic liquid membrane” (SILM). The SILM is sandwiched in between a working electrode and a counter electrode. At least one of the working electrode and counter electrode is perforated so that the test atmosphere, which includes an analyte (typically a gaseous analyte) that is being sensed, can access the SILM. The analyte is electrochemically oxidized at the working electrode. The sensor also includes a power supply that is connected to the working electrode and to the counter electrode, and an ammeter for measuring the current across the two electrodes. The measured current is proportional to the amount of analyte being sensed, and the applied voltage provides information about the identity of the analyte being sensed.

Briefly, a voltage is applied to the working electrode and counter electrode across the SILM. As a test atmosphere diffuses into the SILM, it dissolves in the SILM, and analyte(s) in the test atmosphere is (are) oxidized at the working electrode and/or reduced at the counter electrode. During the oxidation and reduction, an electrical current is produced. The magnitude of the current is proportional to the amount of dissolved analyte being oxidized and/or reduced. The voltage used must be sufficient to cause oxidation of the dissolved analyte. Therefore, this voltage provides information about the identity of the analyte because the oxidation will not occur at a lower voltage.

The sensor invention can be used for selectively detecting a chemical compound in the presence of other compounds by adjusting the voltage of the sensor in order to selectively oxidize only one component of a test atmosphere. For example, if there are two gases in the test atmosphere, a first that is oxidized at 1 volt and a second at 2 volts, measuring the amount of each of these gases in the test atmosphere could be accomplished by first setting the voltage to a value of at least one 1 volt but less than 2 volts. In this voltage range, only the first gas will be oxidized (and therefore measured). After measuring the current due to the first gas (which is proportional to the amount of the first gas in the test atmosphere), the amount of the second gas would be measured by setting the voltage to a value of greater than 2 volts and measuring the current due to the first gas and the second gas. To obtain the current due to the second gas (and therefore the amount of the second gas), the measured current due to just the first gas would subtracted from the measured current for both gases.

The selectivity for analyte detection is affected by the choice of ionic liquid used with the SILM. The ionic liquid may be chosen so that the chemical compound(s) being detected is (are) soluble in the ionic liquid while other compounds are not soluble. The detected compounds should be soluble to permit diffusion through the SILM.

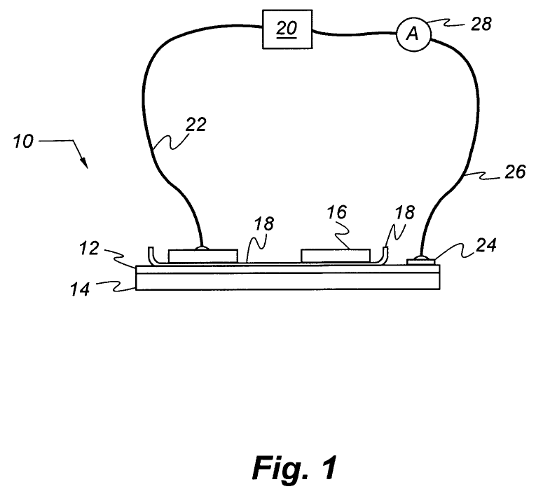

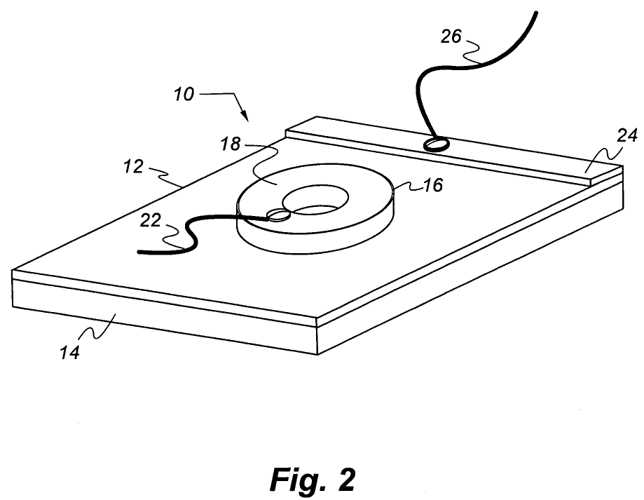

Reference will now be made in detail to the present preferred embodiments of the invention. Similar or identical structure is identified using identical callouts. FIG. 1 shows an edge-on view of an embodiment sensor of the present invention. FIG. 2 shows a top-down view of the embodiment of FIG. 1. As FIG. 1 and FIG. 2 show, sensor 10 includes working electrode 12, which is optionally attached to substrate 14. Exemplary working electrode materials include indium tin oxide (ITO) and fluorine-doped indium tin oxide (FITO). Substrate 14, when used, is typically flat, but may also be bent or curved, or have any other shape. An embodiment sensor of the present invention employed an ITO working electrode supported on a flat piece of glass.

Sensor 10 also includes counter electrode 16. Counter electrode 16 is made from a suitable conductive material such as stainless steel, iron, copper, copper-beryllium, tin-plated copper, aluminum, silver and the like. Counter electrodes made from perforated metal sheets and woven metal wire mesh may be used. A perforated silver plate or silver wire mesh coated with a thin layer of silver (I) salt such as silver chloride or silver bromide may be used as a counter electrode. In this embodiment, the perforated silver plate or silver wire mesh counter electrode may act both as a counter electrode and as a reference electrode against which the potential of working electrode 12 may be referenced. It should be understood that counter electrode 16 is not limited to any particular shape. In an embodiment, a small flat polished stainless steel washer was used as a counter electrode (see EXAMPLE 1, vide infra).

Sensor 10 includes supported ionic liquid membrane 18 (SILM), which physically separates working electrode 12 from counter electrode 16, and maintains electrical contact with working electrode 12 and counter electrode 16. SILM 18 includes a porous solid support and ionic liquid electrolyte in the pores and on the surface of the porous solid support. An embodiment of the sensor employed a support made from porous paper (see EXAMPLE 1, vide infra). Preferably, the amount of ionic liquid used should be sufficient to wet the porous support without dripping or running.

SILM 18 may optionally include dispersed inorganic materials such as, but not limited to, silica and alumina. These materials are electrochemically inert and may form thixotropic gels to assist with retention of low viscosity ionic liquids. The SILM may also include stiffening agents, which may be added to the ionic liquid electrolyte to increase the viscosity of the electrolyte without changing ionic conductivity. Examples of stiffening agents include, but are not limited to, organic monomers and polymers such as polyacrylonitrile, polyvinlidene fluoride, hexafluoropropylene, polyvinvyl alcohol, polyvinylacetate, polymethylmethacrylate and their copolymers. These polymers may be formed in-situ or cross-linked in situ by polymerization of monomers (see, for example, U.S. Pat. No. 6,420,036 to D. V. Varaprasad entitled “Electrochromic Polymeric Solid Films, Manufacturing Electrochromic Devices Using Such Solid Films, and Processes for Making Such Solid Films and Devices,” issued on Jul. 16, 2002). Polymethylmethacrylate, for example, may be formed by adding methylmethacrylate to the ionic liquids and then adding benzoyl peroxide to initiate the polymerization.

Preferably, SILM 18 has a thickness of from about 5 microns to about 5000 microns. More preferably, SILM 18 has a thickness of from about 10 microns to about 500 microns.

Sensor 10 also power source 20 (a battery, power pack, electrical outlet, power generator, or the like), which supplies electrical power to sensor 10. Electrical connection 22, typically a wire connection, connects power source 20 to counter electrode 16.

Sensor 10 optionally includes bus bar 24, which is attached to working electrode 12. Bus bar 24 is typically made from a conductive metallic material and provides good electrical contact to working electrode 12. Exemplary metallic materials include, but are not limited to, silver frits, silver epoxy, solder alloys, metallic strips, wires and clips. Preferred metals include copper, copper-beryllium, and tin plated copper. Electrical connection 26, typically a wire, connects bus bar 24 to power source 20 and to ammeter 28.

The sensor of the present invention may be used for sensing analytes present in a test atmosphere. The test atmosphere passes through the perforation(s) in working electrode 12 and/or counter electrode 16, and dissolves in the ionic liquid present in SILM 18. The dissolved analytes are oxidized at working electrode 12. An electrochemical reduction reaction also takes place at counter electrode 16. Gases such as carbon dioxide and oxygen that are present in the test atmosphere are reduced at counter electrode 16. Other possible reduction reactions taking place at counter electrode 16 include, but are not limited to, reduction of a metal oxide and/or other metal ions present in or on counter electrode 16, and reduction of trace amounts of water present in SILM 18. The oxidation and reduction reactions result in a measurable electric current in sensor 10.

Alternatively, the current may be held constant and the voltage may be measured.

It is preferable that working electrode 12 and counter electrode 16 do not degrade during operation.

An embodiment sensor of the invention may include a reference electrode (such as a Ag/AgCl electrode) against which the potential of working electrode 12 and counter electrode 16 may be referenced.

Ionic liquids used with the invention are aprotic (i.e. they do not dissociate a proton), highly conductive, and thermally stable to the extremes of high and low temperatures of the external environment. Preferred ionic liquids used with this invention remain as liquids at temperature below about −40 degrees Celsius (i.e. the ionic liquids have a glass transition temperature, T_{g}, of less than about −40 degrees Celsius). Preferred ionic liquids do not decompose or evaporate substantially when heated to a temperature of about 100 degrees Celsius under a vacuum of about 10-5 torr for about 72 hours.

Under normal operating conditions, preferable ionic liquids are not substantially oxidized at working electrode 12 and/or reduced at counter electrode 16. Ionic liquids used with this invention have a large ‘electrochemical window’. The electrochemical window is the difference between the oxidation potential and the reduction potential of the ionic liquid. Preferred ionic liquids have an electrochemical window of at least 4 volts.

Preferable ionic liquids should be sufficiently hydrophobic to prevent large amounts of water from dissolving into the ionic liquid because the electrochemical oxidation and reduction of any additional dissolved water produces a signal that cannot easily be distinguished from signal of analyte(s) being sensed. For this reason, aprotic ionic liquids are preferred for this invention. A carbon monoxide sensor described in the Ph.D. dissertation by Y. Abu-Lebdeh entitled “Proton-Conducting Polymer Electrolytes for Carbon Monoxide Sensors” employed a homogeneous conducting polymer film prepared with a protic, hydrophilic ionic liquid. The sensor showed no response without being pre-equilibrated with water. This humidity dependence was likely due to employment of a hydrophilic ionic liquid. By contrast, the present invention avoids this problem by employing hydrophobic, aprotic ionic liquids, which also provide the additional advantage of a larger electrochemical window compared to protic ionic liquids.

Aprotic hydrophobic ionic liquids used with this invention have the advantage of being poorly soluble in water. Consequently, exposure of the sensor of this invention to water does not result in loss of ionic liquid from SILM 18.

Ionic liquids having low water solubility are preferred because any dissolved water will produce an electrical signal in the sensor due to the oxidation of water at the working electrode and the reduction of water at the counter electrode.

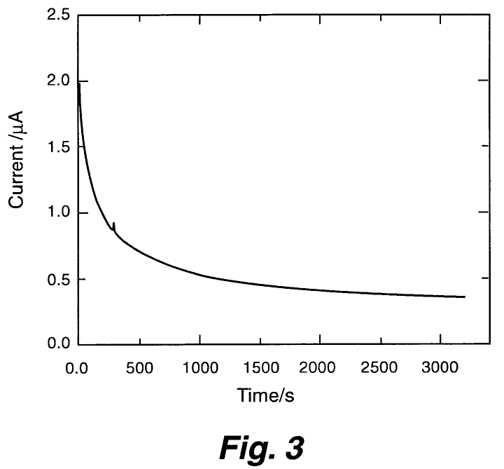

While low solubility of water in the ionic liquid and low solubility of the ionic liquid in water is preferred, the sensor is still operable with a small amount of water (less than about 5 weight percent) in the ionic liquid. FIG. 3 shows a baseline graph of the current-time response of the embodiment sensor of FIG. 1 in the absence of sensed analyte. There is a trace amount of water in the ionic liquid of the SILM. FIG. 3 shows a high current signal at time equals 0-500 seconds, which decreases until the rate of water oxidation and the rate of water dissolution into the SILM become about equal. At times greater than about 1500 seconds, the rate of change of the baseline signal becomes very small. This baseline signal is subtracted from any signal produced by sensed analyte.

Preferred ionic liquids of the invention have cations selected from lithium cations and quaternary ammonium cations (see J. Sun et al., “Room Temperature Molten Salts Based on the Quaternary Ammonium Ion,” J. Phys. Chem. B, 1998, vol. 102, pp. 8858-8864, incorporated by reference). Preferred quaternary ammonium cations include tetraalkylammonium, pyridinium, pyridazinium, pyrimidinium, pyrazinium, imidazolium, pyrazolium, thiazolium, oxazolium, and triazolium (see U.S. Pat. No. 5,827,602 to V. R. Koch et al. entitled “Hydrophobic Ionic Liquids,” which issued Oct. 27, 1998, incorporated by reference herein). Other preferred quaternary ammonium cations include those of the formula [(CH₃CH₂)₃N(R₁)]⁺, wherein R₁ is alkyl having 2-10 carbons; and those of the formula [(CH₃)₂(CH₃CHCH₃)N(R₂)]⁺, wherein R₂ is alkyl having 2-10 carbons; and also those of the formula 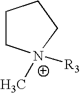
wherein R₃ is alkyl having 2-10 carbons; and those of the formula 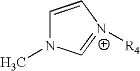
wherein R₄ is alkyl having 2-10 carbons.

Tetraalkylammonium cations are most preferred because they have the least optical absorbance in the ultraviolet portion of the spectrum, which gives ionic liquids that include tetraalkylammonium cations high photochemical stability.

Preferred anions of the ionic liquids used with this invention include fluorine-containing anions. Most preferred anions include trifluoromethylsulfonate (CF₃SO₃⁻), bis(trifluoromethylsulfonyl)imide ((CF₃SO₂)₂N⁻), bis(perfluoroethylsulfonyl)imide ((CF₃CF₂SO₂)₂N⁻) and tris(trifluoromethylsulfonyl)methide ((CF₃SO₂)₃C⁻) because of their low cost and ability to form ionic liquids with high hydrophobicity.

It should be understood that the ionic liquids of this invention do not include anions such as tetrafluoroborate (BF₄⁻) and hexafluorophosphate (PF₆⁻) because these anions are known to decompose and generate hydrofluoric acid (HF). A sensor having ionic liquid with the PF₆⁻ anion has been described by R. Wang et al. in “O₂ Gas Sensor Using Supported Hydrophobic Room-Temperature Ionic Liquid Membrane-Coated Electrode”. According to R. Wang et al. the use of this sensor for detecting oxygen is restricted to a dry gas stream.

It is preferable that SILM 18 does not change shape after sensor 10 is assembled, and does not exhibit creep, fracturing, elongation, distortion, expansion, or contraction while being compressed between working electrode 12 and counter electrode 16 during use.

Preferably, SILM 18 does not degrade (chemically, electrochemically, or otherwise) in the test atmosphere, which may include, for example, water, oxygen, carbon dioxide, sulfides, nitrogen oxides, petroleum products, petroleum combustion products, airborne soil, biological fluids, biological gases, biological slimes and moulds and lichens, viruses, bacteria, biological warfare agents, nerve gas agents, surrogates for nerve gas agents, and other materials.

Preferably, the ionic liquid used is viscous enough so that it does not drain away when the sensor vibrates or moves. Preferred viscosities are in the range of from about 20 centipoise (cP) to about 160 cP at a temperature of about 30 degrees Celsius.

The small quantity of ionic liquid present in the SILM provides a chemically stable, physically robust, non-volatile, adsorbing medium for analyte. Other non-invention type devices employ more volatile electrolytes that evaporate, react with the analyte, react with atmospheric water, react with atmospheric carbon dioxide, leak from the device upon physical vibration or movement or change in orientation, wash out with water, or take up water to give an erroneous electrochemical response for the analyte.

The ionic liquid provides the sensor of this invention with electrolyte and solvent for the analyte(s) being sensed. Non-ionic liquid cosolvents are preferably not used.

The SILM is preferably a thin film (having a thickness of less than about 1 mm) in order to minimize the amount of time for the analyte(s) being sensed to diffuse into the SILM and to the working electrode.

The following EXAMPLES illustrate embodiments of the invention.

### EXAMPLE 1

An embodiment sensor was constructed using a rectangular plate of flat glass, 2″ long, 1.5″ wide. A layer of indium-tin oxide (ITO) having a sheet resistivity of 7Ω/square was attached to one side of the plate. The plate was washed and dried. A 1.25″ diameter circular piece of lint free porous tissue paper was placed on the ITO-covered side of the plate. Four drops of the ionic liquid 1-butyl-3-methylimidazolium bis(trifluoromethanesulfonyl)imide were placed on the tissue paper. Afterward, the plate was heated to about 60 degrees Celsius to lower the viscosity of the ionic liquid to permit rapid penetration of the ionic liquid through the porous tissue paper, thereby forming a supported ionic liquid membrane (SILM). A stainless steel washer having a diameter of about 1 inch was polished on one face, first with 200 grit sandpaper and then 400 grit sandpaper, to remove burrs and protrusions that might puncture the SILM. The washer was then washed and dried, and then placed in the center of the SILM with the polished face in contact with the SILM. Spring-loaded clips were attached across the washer and the plate to hold the sensor together and ensure good contact between the ITO and the SILM and between the SILM and the polished face of the stainless steel washer. Wires were attached using spring clips to the ITO and the washer to allow electrical connection to a voltage power supply (Model CHI730A POTENTIOSTAT, CH INSTRUMENTS INC, TX). The power supply was used to supply a potential difference of 2.5 volts between the ITO layer and the washer, and the electric current was monitored. FIG. 3 shows a baseline graph of the current-time response of the embodiment sensor. As FIG. 3 shows, in the absence of a test atmosphere, a continuously declining current transient was observed. Without wishing to be bound by any particular theory or explanation, it is believed that this current is due to the oxidation and reduction of trace water present in the ionic liquid at the ITO layer (i.e. the working electrode) and the washer (i.e. the counter electrode), respectively. The magnitude of the electric current decreases with time as this trace water is consumed. After a sufficient period of time, the current will likely represent the rate at which this trace water is replenished from the atmosphere.

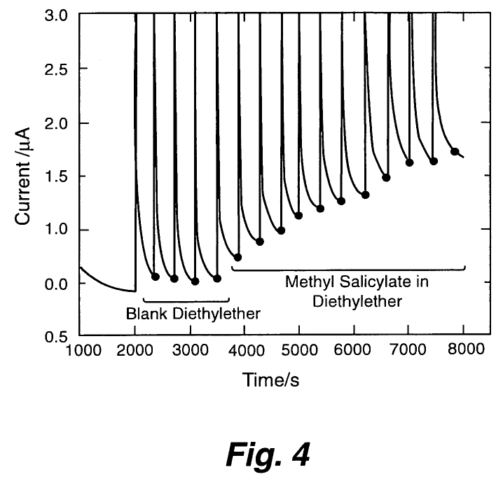

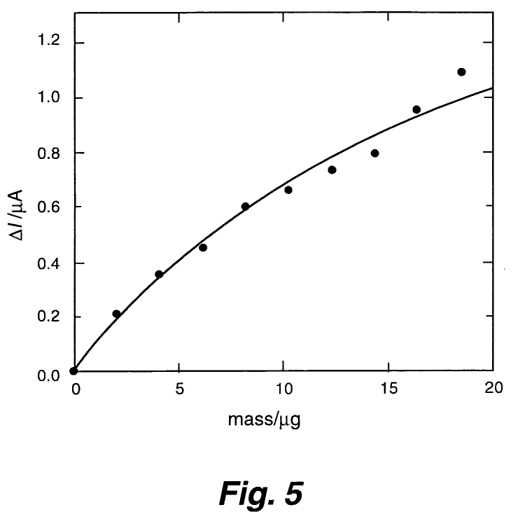

The detector was then tested using the volatile organic compound (VOC) methylsalicylate. Methylsalicylate has been reported as a useful surrogate for the nerve gas agent VX (o-ethyl S-(2-diisopropylamino)ethyl methylphosphonothiolate). To accurately control the minute quantities of methylsalicylate exposed to the sensor, small volumes of a dilute solution of methylsalicylate in diethylether were administered using a microliter syringe to the SILM in the center of the hole in the washer. Use of diethylether as a diluent requires confirmation that the sensor does not respond to this solvent. FIG. 4 shows the oxidation current as a function of time for four sequential 5-microliter additions of diethylether to the detector at a temperature of 20 degrees Celsius. Immediately after each addition, a rapid current spike is observed followed by a decay to close to the current observed prior to the 5-microliter addition. It is believed that the current spike is primarily due to a combination of a dilution of the ionic liquid of the SILM (which leads to more rapid mass transfer) and some physical alteration of the SILM. At a temperature of 20 degrees Celsius, the diethylether rapidly evaporates and the detector current returns to its prior state. Immediately following the four sequential 5-microliter additions of diethylether, nine sequential 5-microliter additions of solution of methylsalicylate in diethylether (0.412 μg/μL) were made to the detector. After the current spike characteristic of diethylether decayed, the current progressively increased with each successive addition of methylsalicylate. The current-time coordinates for use in determining the average response to pure diethylether and the response to successive additions of methylsalicylate are shown as solid dots in FIG. 4. FIG. 5 shows these selected current-time coordinates as a change in current, ΔI, compared to the average current prior to each addition of pure diethylether. This change in current, ΔI, increases with increasing loading of methylsalicylate onto the sensor, demonstrating the capability of the sensor to detect this compound. The limit of detection for the device for methylsalicylate may be estimated from three times the standard deviation, σ, for the current for four sequential 5 microliter additions of diethylether (3σ=0.033 μA). Interpolation of the smooth curve through the data shown in FIG. 5 indicates a detection limit of about 0.33 μg.

### EXAMPLE 2

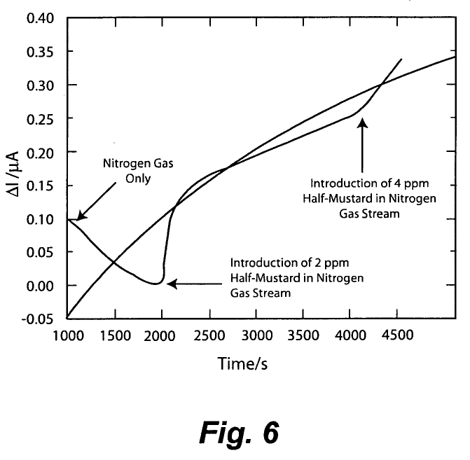

A second embodiment sensor was prepared as described in EXAMPLE 1, with the exceptions of using a smaller glass plate (1″ length, ⅝″ width) and a smaller washer (⅜ inch in diameter). After assembling the sensor, it was placed in a gas flow cell connected to a perfusion apparatus to control delivery of the analyte to the detector. The analyte used was half-mustard (2-chloroethylethylsulfide) as a gas in a stream of nitrogen gas. FIG. 6 shows the detector current as a function of time for exposure to pure nitrogen (0-2000 seconds), 2 parts per million (ppm) of half-mustard (at 2000 seconds), and 4 ppm of half-mustard (at 4150 seconds). The sensor response is provided as the change in current ΔI. The change in current is the difference between the observed current at a given time and the current immediately prior to the first introduction of 2 ppm of half-mustard gas, which is at time equals 2000 seconds. The sensor responds to 2 ppm of half-mustard with a rapid increase in current in the first 100 or so seconds (1.3 nA/s) followed by a more gradual increase over the next 1500 seconds. When the amount of half-mustard analyte was increased to 4 ppm, there was no rapid increase as before; instead, a steady increase in current was observed (0.18 nA/s). It is believed that the rapid increase in current after exposure to 2 ppm of half-mustard is due to rapid diffusion of half-mustard into and through the SILM followed by gradual progressive dissolution into the ionic liquid. The sensor may be used to detect half-mustard by monitoring the rapid increase in current following first exposure to half-mustard, and then quantify the half-mustard by monitoring of the rate of the gradual increase in current after prolonged exposure.

In summary, the invention is concerned with a sensor whose performance is substantially unaffected by changes in humidity. The sensor provides analyte detection on-demand by applying a suitable voltage across the working electrode and counter electrode of the sensor so that the working electrode has a potential more positive than that required to oxidize the analyte. Test atmosphere containing analyte enters the perforated counter electrode side is adsorbed and dissolved in the ionic liquid of the supported ionic liquid membrane (SILM), diffuses through the SILM to the working electrode, and is oxidized. This electrochemical oxidation of the analyte produces an electric current, the magnitude of which is related to the analyte concentration in the test atmosphere. The sensor response is rapid because the SILM is thin and represents only a short diffusion path length from the atmosphere to the working electrode. The sensor employs supported aprotic, hydrophobic ionic liquids. An embodiment of the sensor prepared using 1-butyl-3 methylimidazolium bis(trifluoromethylsulfonyl)imide was able to detect methyl salicylate and half mustard. It is expected that the potential of the sensor can be adjusted and swept to detect other materials.

The foregoing description of the invention has been presented for purposes of illustration and description and is not intended to be exhaustive or to limit the invention to the precise form disclosed, and obviously many modifications and variations are possible in light of the above teaching.

The embodiment(s) were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A sensor comprising:
a first electrode;
a second electrode;
a porous support in electrical communication with said first electrode and said second electrode, said porous support comprising aprotic ionic liquid having anions selected from the group consisting of trifluoromethylsulfonate (CF₃SO₃⁻), bis(trifluoromethylsulfonyl)imide ((CF₃SO₂)₂N⁻), bis(perfluoroethylsulfonyl)imide ((CF₃CF₂SO₂)₂N⁻) and tris(trifluoromethylsulfonyl)methide ((CF₃SO₂)₃C⁻);
an electrical power source for providing a voltage difference between said first electrode and said second electrode;
an ammeter in electrical communication with said first electrode and said second electrode; and
wherein at least a portion of said porous support is capable of contacting an analyte.

2. The sensor of claim 1, further comprising a voltmeter for measuring the voltage across said porous support.

3. The sensor of claim 1, wherein at least one of said first electrode and said second electrode is perforated.

4. The sensor of claim 1, wherein said aprotic ionic liquid comprises cations selected from the group consisting of lithium cations and quaternary ammonium cations.

5. The sensor of claim 4, wherein said quaternary ammonium cations are selected from the group consisting of tetraalkylammonium, pyridinium, pyridazinium, pyrimidinium, pyrazinium, imidazolium, pyrazolium, thiazolium, oxazolium, triazolium, cations of the formula of the formula [(CH₃CH₂)₃N(R₁)]⁺, wherein R₁ is alkyl having 2-10 carbons;
or of the formula [(CH₃)₂(CH₃CHCH₃)N(R₂)]⁺, wherein R₂ is alkyl having 2-10 carbons;
or of the formula 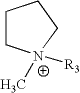
wherein R₃ is alkyl having 2-10 carbons;
or of the formula 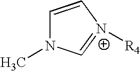
wherein R₄ is alkyl having 2-10 carbons.

6. A sensor comprising:
a first electrode;
a second electrode;
a porous support in electrical communication with said first electrode and said second electrode, said porous support comprising aprotic ionic liquid having an electrochemical window of at least 4 volts;
an electrical power source for providing a voltage difference between said first electrode and said second electrode;
an ammeter in electrical communication with said first electrode and said second electrode; and
wherein at least a portion of said porous support is capable of contacting an analyte.

7. A method for sensing analyte comprising:
exposing a porous support comprising aprotic ionic liquid to an analyte, the aprotic ionic liquid having anions selected from the group consisting of trifluoromethylsulfonate (CF₃SO₃⁻), bis(trifluoromethylsulfonyl)imide ((CF₃SO₂)₂N⁻), bis(perfluoroethylsulfonyl)imide ((CF₃CF₂SO₂)₂N⁻) and tris(trifluoromethylsulfonyl)methide ((CF₃SO₂)₃C⁻);
applying a controlled voltage difference across the porous support; and thereafter
measuring the current flowing across the porous support.

8. The method of claim 7, wherein the aprotic ionic liquid comprises quaternary ammonium cations selected from the group consisting of tetraalkylammonium, pyridinium, pyridazinium, pyrimidinium, pyrazinium, imidazolium, pyrazolium, thiazolium, oxazolium, triazolium, cations of the formula [(CH₃CH₂)₃N(R₁)]⁺, wherein R₁ is alkyl having 2-10 carbons;
or of the formula [(CH₃)₂(CH₃CHCH₃)N(R₂)]⁺, wherein R₂ is alkyl having 2-10 carbons;
or of the formula 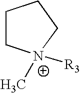
wherein R₃ is alkyl having 2-10 carbons;
or of the formula 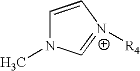
wherein R₄ is alkyl having 2-10 carbons.

9. A method for sensing analyte comprising:
exposing a porous support comprising aprotic ionic liquid to an analyte, the aprotic ionic liquid having anions selected from the group consisting of trifluoromethylsulfonate (CF₃SO₃⁻), bis(trifluoromethylsulfonyl)imide ((CF₃SO₂)₂N⁻), bis(perfluoroethylsulfonyl)imide ((CF₃CF₂SO₂)₂N⁻) and tris(trifluoromethylsulfonyl)methide ((CF₃SO₂)₃C⁻);
applying a controlled electrical current across the porous support; and thereafter
measuring the voltage across the porous support.

10. The method of claim 9, wherein the aprotic ionic liquid comprises quaternary ammonium cations selected from the group consisting of tetraalkylammonium, pyridinium, pyridazinium, pyrimidinium, pyrazinium, imidazolium, pyrazolium, thiazolium, oxazolium, triazolium, cations of the formula [(CH₃CH₂)₃N(R₁)]⁺, wherein R₁ is alkyl having 2-10 carbons;
or of the formula [(CH₃)₂(CH₃CHCH₃)N(R₂)]⁺, wherein R₂ is alkyl having 2-10 carbons;
or of the formula 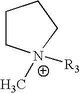
wherein R₃ is alkyl having 2-10 carbons;
or of the formula 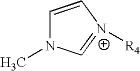
wherein R₄ is alkyl having 2-10 carbons.

11. A sensor comprising:
a first electrode;
a second electrode;
a porous support in electrical communication with said first electrode and said second electrode, said porous support comprising aprotic ionic liquid having a glass transition temperature, Tg, of less than about −40 degrees Celsius;
an electrical power source for providing a voltage difference between said first electrode and said second electrode; and
an ammeter in electrical communication with said first electrode and said second electrode;
wherein at least a portion of said porous support is capable of contacting an analyte.

12. A sensor comprising:
a first electrode;
a second electrode;
a porous support in electrical communication with said first electrode and said second electrode, said porous support comprising aprotic ionic liquid that does not decompose when heated to a temperature of about 100 degrees Celsius under a vacuum of about 10⁻⁵ torr for about 72 hours;
an electrical power source for providing a voltage difference between said first electrode and said second electrode; and
an ammeter in electrical communication with said first electrode and said second electrode;
wherein at least a portion of said porous support is capable of contacting an analyte.
